(19) United States
(12) Patent Application Publication
(10) Pub. No.: US 2022/0134614 A1
(43) Pub. Date: May 5, 2022

(54) OVERMOLDING DEVICE HAVING A TURNTABLE AND A CLOSING SIDE DIVIDED INTO THREE PARTS

(71) Applicant: Stefan Pfaff Werkzeug- und Formenbau GmbH & Co KG, Roethenbach (DE)

(72) Inventor: Anton SUTTER, Weiler-Simmerberg (DE)

(21) Appl. No.: 17/453,312

(22) Filed: Nov. 2, 2021

(30) Foreign Application Priority Data
Nov. 3, 2020 (EP) 20205555.4

(51) Int. Cl. B29C 45/04; B29C 45/14; B29C 45/73

(52) U.S. Cl. CPC B29C 45/045; B29C 45/7312; B29C 45/14

(57) ABSTRACT

In order to increase the degree of automation, an overmolding device for processing profiles, having a turntable with a worktable device that is movable in rotation about an axis of rotation in a rotation plane and has at least two processing areas, is proposed, wherein the processing areas each comprise a central plate, wherein the central plate is attached to and/or mounted on the worktable via a central-plate receptacle, wherein the turntable comprises an upper and a lower mold, which are decoupled from the rotation of the worktable device and which are arranged opposite one another with regard to the rotation plane, and wherein the upper and lower mold are movable such that, together with the central plate, they form a mold receiving the profile, and the central-plate receptacle (5) forms the fixed closing side and the upper and lower molds form the movable closing side.

### CROSS-REFERENCES TO RELATED APPLICATION

This application claims the benefit of European Application No. 20205555.4, filed Nov. 3, 2020, the entirety of which is incorporated herein by reference, further the entirety of the attached translation of European Application No. 20205555.4 is incorporated by reference.

### FIELD OF THE INVENTION

This disclosure relates to an overmolding device for processing profiles, in particular for overmolding partial profiles, end portions or the like.

### BRIEF SUMMARY

An overmolding device for processing profiles, in particular for overmolding partial profiles, end portions or the like, includes at least one processing station for carrying out a processing step there, and a turntable with a worktable device that is movable in rotation about an axis of rotation in a rotation plane and has at least two processing areas, wherein the processing areas each comprise a central plate. The central plate is attached to and/or mounted on the worktable device in each case via a central-plate receptacle. The processing areas are arranged in a circle about the axis of rotation such that the central plates are each movable from one of the processing stations to the next. The central plates have a mold for receiving the profile, in order to laterally delimit the profile in the rotation plane. The turntable comprises an upper and a lower mold, which are decoupled from the rotation of the worktable device and which are arranged opposite one another with regard to the rotation plane. The upper and lower mold are movable such that, together with the central plate, they form a mold receiving the profile, and the central plate and/or the central-plate receptacle form the fixed closing side and the upper and lower molds form the movable closing side.

### BRIEF DESCRIPTION OF THE DRAWINGS

FIG. 1 shows a schematic illustration of an example overmolding device.

FIG. 2 shows a schematic section through an example worktable device.

FIG. 3 shows a schematic illustration of an example coolant circuit system.

FIGS. 4-6 show schematic illustrations of an example quick clamping system.

### DETAILED DESCRIPTION

Numerous overmolding devices are known from the prior art. On account of the complex mechanical properties of flexible profiles, as are used for example for door seals in vehicles, and the moreover high demands placed on accuracy in the manufacturing process, use is made, between individual processing steps, of manual handling or manual logistics in order to transfer the corresponding profiles from one processing step to the next. For example, after a processing step such as the extrusion of individual profiles that are to be processed further (profile blanks) or after the execution of cutting operations on the profiles, these are each taken out of the mold and, respectively, placed in a new mold manually by operators, in order to pass the profiles from the previous processing operation to the next processing step. Subsequently, the profiles are then cut or overmolded.

One embodiment disclosed herein increases the degree of automation in the manufacture of profiles.

The overmolding device according to an embodiment is used to process profiles, on which for example partial profiles or end portions are overmolded. It is also conceivable in principle for further processing steps to be integrated therein depending on the embodiment. For this purpose, the overmolding device comprises at least one processing station for carrying out a processing step there; in particular, such a processing step is the overmolding operation to be carried out. In addition, processing steps can alternatively be understood to be for example manufacturing steps in which the profile is merely placed and positioned in the mold, i.e. a profile is inserted into the mold. It is also conceivable, to analogously refer to an ejection operation as a processing step, when the profiles are correspondingly removed. Furthermore, it is possible in principle, as already outlined, for further processing steps to be carried out, for example the execution of trimming operations on the profiles.

The overmolding device according to an embodiment is now distinguished, inter alia, by the fact that a turntable with a worktable device is provided. The worktable device is the area that can rotate or is movable in rotation about an axis of rotation in a rotation plane in order to be able to change between at least two processing areas that are arranged on the worktable device. Each processing area comprises in this case a central plate in which a profile can be received in order to be processed. The central plate itself is attached to or mounted on the corresponding worktable device in each case via a central-plate receptacle.

As a result of the worktable device being rotated, the processing areas are each moved into the same, precisely predefined positions, in which the profile is processed by a processing station. Each processing area is moved into each position during the manufacturing process. The processing areas are thus arranged in a circle or on a circular line around the axis of rotation such that the central plates are each movable from one processing station to the next.

To receive the profile, the central plates have a mold or form a part of the mold and can thus laterally delimit the profile in the rotation plane.

In order for it to be possible to carry out the overmolding operation, the profile has to be enclosed within the entire mold. To this end, the turntable has an upper and a lower mold, which, according to an embodiment, are decoupled from the rotation of the worktable device and which are arranged opposite one another with regard to the rotation plane. In this way, the upper and lower mold form the movable closing side, while the central plate or the central-plate receptacle form the fixed closing side. If, in one embodiment, the central plate is mounted in a movable or floating manner in the central-plate receptacle, the central plate is accordingly itself also a movable closing side. In this case, the fixed closing side is formed only by the central-plate receptacle, which is fastened directly to the worktable device.

The overmolding device according to an embodiment has in particular the advantage that the profiles can be fed and deposited automatically without the involvement of an operator. As a result of the overmolding device being embodied with a turntable, space-saving and rapid manufacture is allowed. The arrangement on a turntable also simplifies in particular automation, ensures rapid processing and ultimately means that an operator for handling the profiles can be dispensed with. The automated insertion and removal of the profiles is made easier by the fact that a closing side or mold divided into three parts is provided. The only part of the mold that guides the profile from processing station to processing station is the central plate potentially having inserts or receiving strips, which delimits this profile only laterally, thereby making it much easier to insert and remove a flexible profile. Nevertheless, the profile is guided in a stable position on the path to processing, and so high-precision production of the profiles is possible.

In particular, an embodiment affords the advantage that manual handling of the profiles can typically be avoided between the execution of trimming operations and the actual overmolding operation, and the automated handling, proposed according to an embodiment, bridges these two processing steps. The nozzle device for the actual overmolding on the profile, i.e. either for connecting a profile to a further partial profile or for overmolding profile end portions, can be arranged in the region of the upper mold or in principle also in the region of the lower mold. As a rule, the nozzle device is attached to the upper mold, while the lower mold forms the contour side or ejection side. Advantageously, the profile to be processed is mounted in the central plate and moved from processing station to processing station. The upper and lower mold, which are necessary for the overmolding operation and thus form a processing station, are configured in a movable manner and can be moved in the direction of the worktable device in order to enclose the profile in this processing station and carry out the overmolding operation.

Otherwise, the profile, which is mounted in the central plate, is nonetheless independent of the upper and lower mold and can be moved relative thereto. The degree of automation can thus advantageously be increased.

Since, as a result of an embodiment, the insertion and removal of the profile can each be formed by a further processing station, the workspace for a further operator, who otherwise has to place the profiles into the mold and remove them therefrom in a time-consuming and laborious manner, is in principle dispensed with. The space requirement as a whole also does not have to be increased, or not be increased much, by the overmolding device proposed according to an embodiment, because the overmolding operation can advantageously be carried out in a space-saving manner on a turntable.

In one embodiment, the central plate is mounted in a floating manner in the central-plate receptacle such that it is able to be displaced and/or raised as a result of the movement and contact with the movable closing side. As a result of said central plate being mounted in a floating manner, the closing process of the molds before the overmolding operation is considerably simplified, especially since the upper and lower mold are moved toward the central plate from different sides and also center the central plate itself to a certain extent in the process. In this way, it is also possible for the processing accuracy to be increased and the positioning operation simplified. On account of the central plate being mounted in a floating manner in this way, the insertion and removal or profiles can additionally be made easier. The central plate can move easily relative to the profile, and this can be exploited for ejection, since the central plate can be raised for example via the movable closing sides.

In order to eject the profile, in one embodiment, a corresponding ejector can be provided, which is coupled mechanically to a movement of the turntable or to a movement of the upper and/or lower mold. Such an embodiment simplifies in particular automation, because two mechanical operations or movements taking place at the same time do not have to be controlled by independent drives, but rather are connected together, for example, via a transmission and thus take place automatically at the same time. Furthermore, as a result, an additional drive can be dispensed with, this entailing corresponding cost advantages. In this way, the processing step of ejection can also be included in automation.

The worktable device is configured to be movable in rotation. A profile that is located on the worktable device, and more specifically is mounted in the central plate, can thus be moved with its processing area from processing station to processing station. In the adjacent processing areas, respective profiles are likewise mounted, which are moved from processing station to processing station by means of the rotary movement of the worktable device. In order, during each transport step or immediately after each rotary movement of the worktable device, for it to be possible to carry out a processing step, it is therefore advantageous to arrange the central plates, or the processing areas, in each case at equal angular spacings in order that, as a result of the rotary movement of the worktable device, movement takes place from one processing station to the next and thus also the adjacent profile can be guided accordingly from one processing station to the next. As a result, the time required for manufacture and accordingly also costs can be saved.

An embodiment variant of an overmolding device according to an embodiment can be configured for example such that three processing areas are arranged at equal angular spacings on the worktable device, these thus being rotated depending on the temporal sequence such that they allow successive processing operations in all the processing stations. Suitable processing stations are an insertion station, an overmolding station and a removal station. Furthermore, it is also possible in principle to provide further processing areas or processing stations, for instance for carrying out a second overmolding operation, for carrying out trimming operations or the like. In particular, for profile handling (inserting or removing profiles), robots can be assigned to the respective processing station, said robots being arranged for example in a stable position on or next to the turntable and inserting or removing the profiles. This is simplified in that the worktable device is rotated and the same central plate is always used for positioning the profile to be processed. The worktable device always stops its rotary movement such that the processing areas each always come to a standstill at the same point, with the result that the robots can always carry out the same handling operation of the profile. Because a turntable is used, it is furthermore also possible for space to be saved since a working area for a person does not need to be provided. If, however, a linear structure is again used, in which linear transport from processing station to processing station takes place, more space is usually also required overall.

The removal of a profile can be simplified in that, for example, an ejector is provided. The ejector can act, for example, on the central plate and accordingly raise or lower it, and this can advantageously also be coupled directly to a movement, taking place in any case, of the turntable or of the molds. As a result, not only is temporal parallelization easier, but it is also possible to cost-effectively save on a further drive.

The central plate itself can in turn also use a receiving strip for the precise guiding and positionally stable mounting of profiles (flexible profiles or carrier profiles). Since such a receiving strip can also be mounted in a movable manner on the central plate, it can also be used to act in a supporting manner during ejection. This measure can in principle simplify handling.

Furthermore, it is also possible for inserts to be provided, which are attached to the central plate, which form a part of a mold for example during overmolding, for instance in the overmolding area in which the profiles are connected together or where end overmolding takes place. These inserts can also be configured such that, for example, positioning pins, recesses in the profile or the like are shaped via the insert. In this way, the manufacturing process can be handled as flexibly as possible.

In order for it to be possible to supply the rotatably mounted area of the worktable device with energy, it is advantageously possible for contactless energy transfer to be used. In particular, it is advantageous to use inductive energy transfer. In this way, expensive wear contacts, which tend to need maintenance and also considerably increase the friction during the movement and thus the energy expenditure, and complicated cable guides can be avoided. Furthermore, not only is the energy transfer more reliable, but also working with the machine is in principle less dangerous when the energy transfer between parts that move relative to one another does not take place directly via a physically present line but in a contactless manner

To make it easier to work with the machine, it is advantageous in particular to provide a quick clamping system in order for example to fasten and center the central plate relative to the rest of the worktable device, the upper mold relative to the nozzle device and the lower mold relative to the contour side/ejector side. In this way, individual parts and specifically the molds, which need to be exchanged anyway depending on the profile to be produced, can be changed and replaced quickly. Such a quick clamping system can comprise for example an eccentric clamping lever for holding, in a force-fitting manner, the parts to be fastened together. By operating or tilting the lever, the corresponding parts or molds can thus be fastened or released. Furthermore, for holding and for centering, guides or stops can also be provided. The mold to be positioned is inserted and guided via guides. The accuracy of positioning can be increased in that the guiding takes place for example via wedge-shaped faces and the mold is also held in a force-fitting manner Particularly precise positioning can be realized via centering pins.

If, for example, the corresponding mold is introduced via the guide device, centered by means of a centering pin and positioned accurately by contact with a stop, it can be quickly fastened directly in this position via an eccentric clamping lever. As a result, not only is mechanically particularly stable fastening allowed, but quick replacement of individual components is also favored.

In principle, it is advantageous to provide cooling for the individual processing areas and for the work with individual processing stations. A conventional rotary feedthrough for electric current or for the hydraulic line, i.e. both for energy transfer and for the supply and drain of a coolant, would require a central feedthrough in the region of the axis of rotation with substantially radial outflows. However, such an arrangement is made more difficult in principle in that, in the turntable, the center, through which the axis of rotation passes, cannot be used because the region around the worktable device has to be accessible for example for robots for handling and therefore the regions of the processing station that are fixed compared with the worktable device project from the inside into the worktable device or project over the worktable device. In other words, this installation space is not available for a rotary feedthrough to the worktable device. According to a particular embodiment, for this purpose, a dedicated coolant circuit is provided. Initially, a positionally fixed supply line and drain line are provided in order to guide the coolant into respective processing areas and to drain it from these areas again.

These supply and drain lines are located on the turntable fixed in a particular position. Upon rotation of the worktable device, each processing area can be rotated to this corresponding position such that the supply and drain lines are connected to the circuit there.

If the worktable device is rotated further, in order to move the next profile to this processing station, the next processing area can be coupled to the supply and drain lines. However, it is necessary that in principle all processing areas be supplied with coolant. Therefore, it is advantageous to provide the coolant circuit such that the coolant is guided in a circle through the entire worktable device. Since, however, the coupling in through the supply and drain lines takes place in a fixed position, and so the coolant is not always introduced into the worktable device at the same point, a switchover device is advantageously provided at each of the processing areas, in order, depending on whether the processing area is connected to the supply line or drain line, to supply the coolant, after passing through the processing area, to the next processing area or the drain line.

Advantageously, this can be realized by a two pressure valve in one embodiment. A two pressure valve corresponds to a 2-way valve, in which the pressurized line blocks one path and allows passage through another. If the correspondingly other line is pressurized with a pressure that is higher than the pressure on the other side of the supply line, the other path is in turn connected through. By way of the two pressure valve it is advantageously possible to identify whether the cooling area in the respective processing area is connected to the supply line and is thus pressurized, or not. In this way, the coolant circuit is controlled or regulated automatically without a separate monitoring device being present, since the system regulates itself by way of the prevailing pressure conditions.

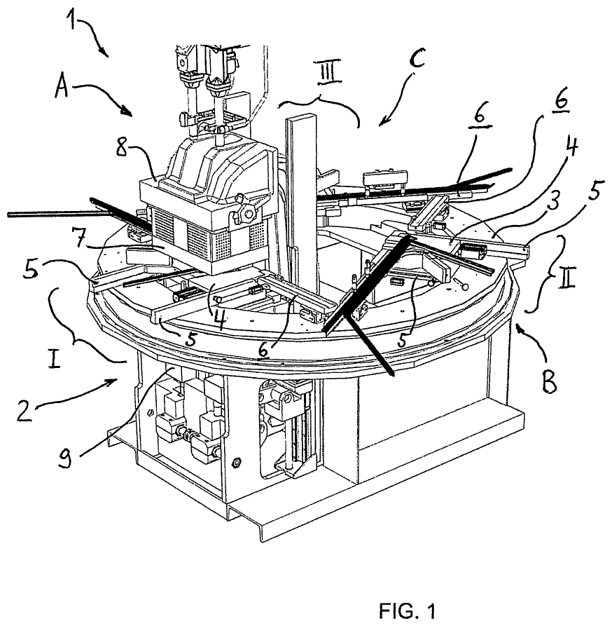

FIG. 1 shows a schematic, perspective illustration of an overmolding device 1 having a turntable 2, which in turn has a worktable device 3. This worktable device 3 is mounted so as to be rotatable relative to the rest of the turntable 2 and is movable in rotation. The worktable device 3 is subdivided into three processing areas I, II, III. The processing areas I, II, III rotate together with the worktable device 3. In contrast thereto, the processing stations A, B, C are attached in a fixed position, wherein, during the rotation of the worktable device 3, the processing areas I, II, III move from one of the processing stations A, B, C to the next (rotate through).

Each processing area I, II, III is equipped in each case with a central plate 4, which is mounted in a floating manner in a central-plate receptacle 5. Furthermore, receiving strips 6 are provided in the region of the central plate 4, said receiving strips 6 serving to mount the profiles in a stable position and also making it easier to eject a profile, since they are mounted in a movable manner and can therefore be tilted, for example.

The processing station A is intended for overmolding on the profiles (for example for connecting to a further partial profile or for end overmolding). To this end, it comprises, above the worktable device 3, an upper mold 7 with a nozzle device 8. The two devices, upper mold 7 and the nozzle device 8, are connected together via a quick clamping system and form a movable closing side, namely the movable nozzle side.

Located beneath the rotation plane or beneath the worktable device 3 is the movable ejector side or contour side, which comprises a lower mold 9.

Upon rotation of the worktable device 3, each processing area I, II, III therefore rotates until all the processing stations A, B, C have each been called at, and the profiles respectively mounted at each processing area I, II, III have thus been fully processed. In principle, however, it is also conceivable for more than three processing areas or processing stations to be provided. In particular, the same number of processing areas as there are processing stations are provided.

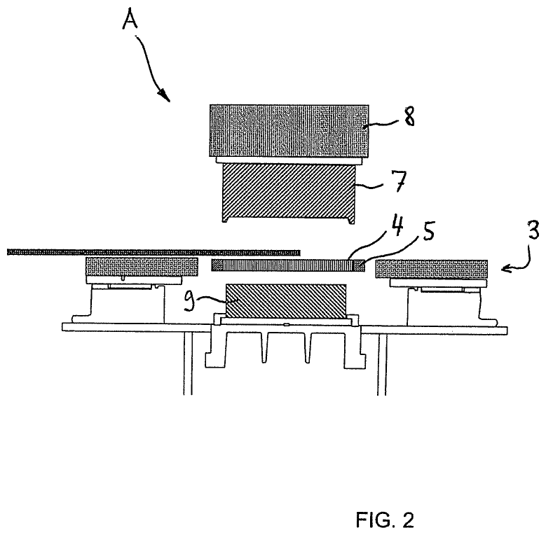

A schematic section through the processing station A is illustrated in FIG. 2. The section runs along a secant through the worktable device 3. The central plate 4 with inserts forms a mold, which can laterally enclose the profile to be processed. It is mounted on the worktable device 3 in a floating manner in a central-plate receptacle 5. Likewise attached are the profile strips in which the profiles (flexible profiles or carrier profiles) can be mounted. The central plate 4 is enclosed upwardly and downwardly in each case by the upper mold 7 and the nozzle device 8, which together form the movable nozzle side, and located in the region beneath the central plate 4 is, in turn, the lower mold 9, which forms the ejector side.

In FIG. 2, the mold is illustrated in an open state. For the actual overmolding, the upper and lower mold 7, 9 are moved in the direction toward the central plate 4 such that the mold as a whole can be closed. Through contact with the molds, the central plate 4, which is mounted in a floating manner in the receptacle 5, can move somewhat. The ejector side can be lowered to such an extent that it can be removed under the annular worktable device 3. The central plate 4 and the nozzle device 8 can be exchanged above the worktable device 3.

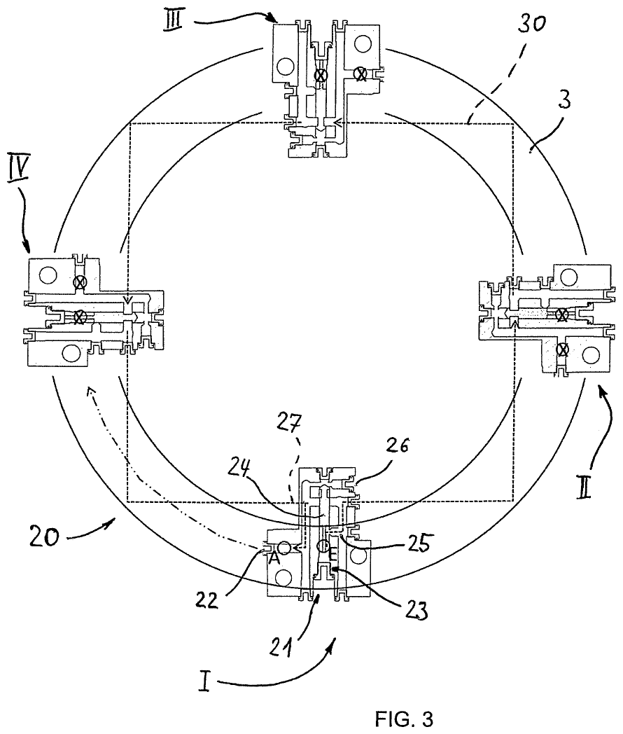

FIG. 3 shows a schematic illustration of the coolant circuit system 20. In this case, the worktable device 3 is again illustrated. Furthermore, the supply line 21 can be seen, which is currently present in the processing area I in the figure. In the present embodiment, a worktable device 3 having a total of four processing areas I, II, III, IV is illustrated. The other three processing areas II, III, IV are not currently connected to the supply and drain lines 21, 22 at the illustrated time. The two pressure valve 23 comprises a piston 24, which, depending on pressurization, is moved through the line 21. Illustrated branching therefrom are two paths 25, 26. In the processing area I, which is connected to the supply line 21, the piston 24 is moved upward in this situation and allows the flow to pass into the path 25. The coolant then flows for cooling purposes through the device and into the circuit 30.

The upper path 26 is in turn blocked for throughflow via the path 27. Via the path 27, the coolant passes out of the actual circuit 30 into the tiny area. In the processing area I, the coolant is therefore guided to the outlet line 22 and can be drained.

By contrast, in the processing areas II, III and IV, the path 25 is closed, and the coolant passes from the path 27 directly to the path 26 and can flow further through the circuit 30 from processing station I, II, III, IV to processing station I, II, III, IV.

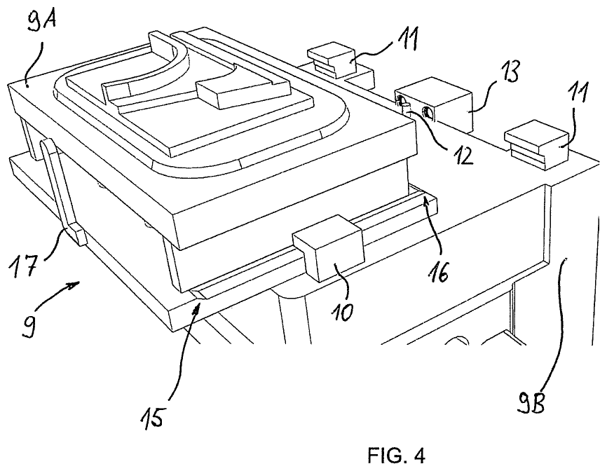

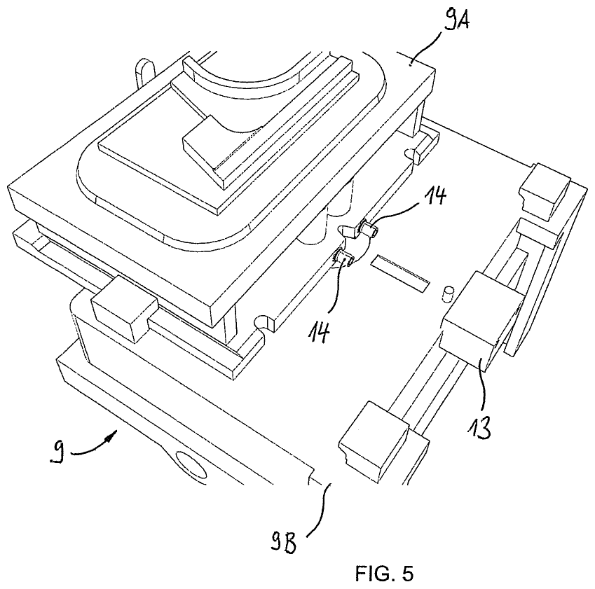

FIG. 4 shows, by way of example, an illustration of the lower mold 9, wherein the actual mold 9A is pushed onto the machine table 9B for assembly. To this end, guides 10 are provided on the machine table 9B, and furthermore stops 11 at the end of the insertion section, as far as which the mold 9A can be moved. Furthermore, a centering pin 12 is provided approximately at the level of the end stops 11. It is clear from FIG. 5 that corresponding centering via the centering pin 12 is important not only for precise positioning of the mold 9 per se, but that precise coupling of the lines 14 can also be ensured thereby. For mold temperature control (cooling), a media transfer station 13 is used, with which the medium (coolant) is transferred via the lines 14 from the media transfer station 13 to the mold 9A and guided back out of the mold 9A.

Furthermore, it is apparent from FIG. 4 that the mold 9A has, in the area in which it comes into contact with the guides 10 or the stops 11, partial surfaces 15, 16 in order to achieve form-fitting positioning. Clamping can also be allowed in principle thereby.

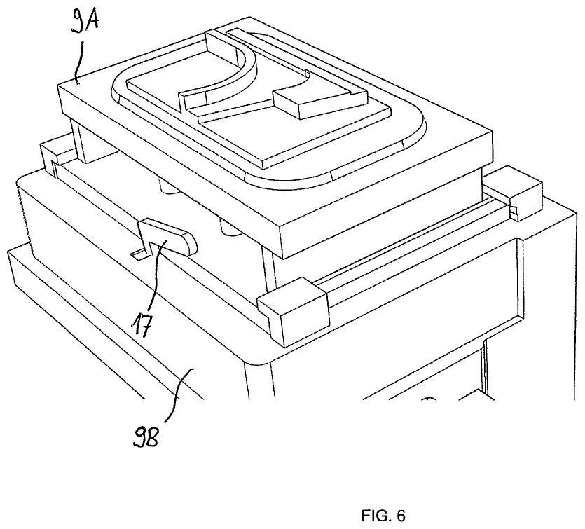

Furthermore, according to FIG. 6, an eccentric clamping lever 17 is provided, which braces the mold 9A held via the guides 10, 11 with respect to the machine table 9B and to this end is rotated in the arrow direction.

In principle, it is also conceivable to provide for example locks via bayonet fittings or the like.

### List of Reference Signs:

1 Overmolding device
2 Turntable
3 Worktable device
4 Central plate
5 Central-plate receptacle
6 Receiving strip
7 Upper mold
8 Nozzle device
9 Lower mold
10 Guide
11 Stop
12 Centering pin
13 Media transfer station
14 Line
15 Partial surface
16 Partial surface
17 Eccentric clamping lever
9A Mold (ejector-side)
9B Machine table
I, II, III, IV Processing area
A, B, C Processing station
20 Coolant circuit system
21 Supply line
22 Drain line
23 Two pressure valve
24 Piston
25 Path
26 Path
27 Path
30 Circuit

1. An overmolding device for processing profiles, in particular for overmolding partial profiles, end portions or the like, comprising:
at least one processing station for carrying out a processing step there, and
a turntable with a worktable device that is movable in rotation about an axis of rotation in a rotation plane and has at least two processing areas, wherein the processing areas each comprise a central plate,
wherein the central plate is attached to and/or mounted on the worktable device in each case via a central-plate receptacle,
wherein the processing areas are arranged in a circle about the axis of rotation such that the central plates are each movable from one of the processing stations to the next,
wherein the central plates have a mold for receiving the profile, in order to laterally delimit the profile in the rotation plane,
wherein the turntable comprises an upper and a lower mold, which are decoupled from the rotation of the worktable device and which are arranged opposite one another with regard to the rotation plane,
wherein the upper and lower mold are movable such that, together with the central plate, they form a mold receiving the profile, and the central plate and/or the central-plate receptacle form the fixed closing side and the upper and lower molds form the movable closing side.

2. The overmolding device of claim 1, wherein the upper or the lower mold has a nozzle device for overmolding on the profile and the other one in each case of the two molds, namely the upper and lower mold, has a contour side, in order for it to be possible to remove the profile after overmolding.

3. The overmolding device of claim 1, wherein the central plate is mounted in a floating manner in the central-plate receptacle such that it is able to be displaced and/or raised as a result of the movement and contact with the movable closing side.

4. The overmolding device of claim 1, wherein an ejector is provided in order to eject the profile for removal, said ejector being mechanically coupled to a movement of the turntable and/or of the upper mold and/or of the lower mold.

5. The overmolding device of claim 1, wherein the central plates and the processing areas are each arranged at equal angular spacings.

6. The overmolding device of claim 1, wherein at least one further processing station is provided, which is configured as an insertion area for inserting the profile and/or a partial profile as a part of the profile.

7. The overmolding device of claim 1, wherein at least one further processing station is provided, which is configured as a removal area for removing the profile and/or a partial profile as part of the profile.

8. The overmolding device of claim 1, wherein the processing station and/or at least one of the processing stations comprises a robot for inserting and/or removing the profile and/or the partial profile.

9. The overmolding device of claim 1, wherein the central plate has at least one receiving strip for mounting the profile and/or a partial profile as part of the profile in a stable position.

10. The overmolding device of claim 1, wherein the central plate has at least one insert for forming a closing side during overmolding.

11. The overmolding device of claim 1, wherein the turntable has an energy-transfer device for contactless energy transfer to the worktable device, in particular for inductive energy transfer.

12. The overmolding device of claim 2, wherein at least one quick-clamping system is provided in order to respectively fasten and/or center:
the central plate relative to the rest of the worktable device and/or
the upper mold relative to the nozzle device and/or
the lower mold relative to the contour side and/or ejector side,
wherein the at least one quick-clamping system comprises in particular:
an eccentric clamping lever for holding, in a force-fitting manner, the parts that are to be fastened together and/or
a guide device having faces molded in a wedge shape for orienting and fastening in a force-fitting manner and/or
at least one centering stop for orienting and centering.

13. The overmolding device of claim 12, wherein a coolant circuit for cooling the processing stations is provided, wherein respective supply and drain lines that are positionally fixed with respect to the worktable device, in order to feed coolant into the worktable device and to drain it from the worktable device in the region of one of the processing areas, and a connecting line with which the coolant is able to be fed to the individual processing areas, in particular connected in series, are provided, wherein each of the processing areas has a switchover device in order, depending on whether the processing area is connected to the supply and drain lines, to feed the coolant, after passing through the processing area, to the next processing area or the drain line.

14. The overmolding device of claim 13, wherein at least one two pressure valve is provided in each processing area in order, when pressurized via the supply line, to open the connection between the connecting line and drain line and otherwise to close it.

15. The overmolding device of claim 12, wherein at least one of the processing stations is configured to cut the profile and/or at least a partial profile.
